(19) United States
(12) Patent Application Publication
(10) Pub. No.: US 2011/0137986 A1
(43) Pub. Date: Jun. 9, 2011

(54) Accessing content hosted on a peer device in a peer-to-peer network using a uniform resource locator (URL)

(76) Inventor: Edward O'Brien Wolf, Fairport, NY (US)

(21) Appl. No.: 12/586,484

(22) Filed: Dec. 8, 2009

(51) Int. Cl. G06F 15/16

(52) U.S. Cl. 709/204; 709/226

(57) ABSTRACT

A system and method allows users to access content that is hosted on a peer device. Additionally, a resource-generating device automatically creates a URL for resources generated on the peer device. The generated resource is accessible from a public network while still on the device via the URL. The system and device further includes an update feed for new and newly-modified resources on the system or device.

### TECHNICAL FIELD

The present invention relates generally to computer networks, and more particularly, to systems and methods that provide URL accessibility to content hosted on a peer-network-hosted.

### BACKGROUND

Users currently generate a significant amount of the popular content that is published on the Internet. Generally, users generate the content and then upload the content to a hosting server operated by a publisher or service provider. There is some concern over the logistics of transferring a large volume of content or assets from a users' computer to a hosting server. For example, uploading assets can be a time-consuming process that is prone to malfunction, which can cause user frustration. Additionally, due to the large volume of user content being uploaded, hosting has become a considerable business expense for the publishers. Further, publishers may have some responsibility for hosted content. Therefore, publishers may have content and ownership restrictions, which may prevent some users from using their services.

Some conventional systems attempt to relieve the publishers of these burdens by allowing a user to publish content on a proprietary website. These systems, however, also require a significant investment of both time and money. Further, there are still additional costs associated with hosting the assets. However, with these conventional systems, the user bears the cost of hosting the assets rather than a publisher.

Peer-to-peer (P2P) networks provide users with the ability to host content on their personal computers, and to make that content public to other peers in the network. However, with P2P networks, the user is generally responsible for the content. Additionally, P2P networks require all users that wish to access the content to join the P2P network, regardless of whether those users wish to join the P2P network. This may not be feasible for, or acceptable to, all people because it may require users to install and operate peer-to-peer software simply to view the desired content. Often times, this can be difficult for some users. Further, users creating the content still need to transfer those assets from a creation device to the hosting computer.

### SUMMARY

The present invention is directed to a system and method of hosting user resources on a peer device in a peer-to-peer (P2P) network such that the resources are accessible from a public network site via a uniform resource locator (URL). In one embodiment, the P2P network further includes an update feed for new and newly-modified resources on the network. In another embodiment, a resource-generating device is configured to automatically create a URL for resources generated on the device. The resource is accessible from a public network via the URL even though the resource still resides on the device. The device further includes an update feed for new and newly-modified resources on the device.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 illustrates a basic configuration of some of the basic components in a network according to one embodiment of the present invention.

FIG. 2 is a flow diagram illustrating a method for a process according to one embodiment of the present invention.

FIG. 3 is a flow diagram illustrating a method for a process according to another embodiment of the present invention.

FIG. 4 illustrates a basic configuration of a network according to the present invention wherein one of the peers aggregates and randomly feeds digital images to one or more non-peer-to-peer image display devices using a RESTful URL of non-addressable images.

### DETAILED DESCRIPTION

The present invention is directed towards a peer-to-peer (P2P) network that hosts digital resources on peer devices. The resources hosted on the peer devices in the network are accessible to others via a uniform resource locator (URL).

In one embodiment, a resource-generating device is a peer device in a peer-to-peer network. The peer device may be, for example, a wireless device that communicates with other peer devices. When a user creates a resource on the peer device, the peer device creates a Uniform Resource Locator (URL) for the resource. The URL identifies the resource and its location on the peer device such that other users can access the resource. The other users may or may not be peers in the P2P network.

The resources may be any digital resource, including, but not limited to, single files or groups of files, digital media such as images, audio files, and video files, and applets. The URL may be a Hypertext Transfer Protocol (HTTP) based URL, an opaque URL, or a URL that conforms to the Representational State Transfer (REST) principles. Uniform Resource Locators that conform to the REST principles are referred to herein as “RESTful” URLs.

The peer devices hosting the resources can also create update feeds for updated and newly-created resources. The update feeds allow for the transmission of URLs generated for the updated and newly-created resources to other peer and non-peer devices. The content update feeds may be Web or Syndicated feeds, such as RSS or Atom Syndication Format, for example.

The present invention provides URL access to single files, groups of files and locally-executing applets by proxying HTTP requests from a well-known host address to an individual PC or cluster of PCs.

The present invention system also creates a URL that can be used in any software application that is compatible with an HTTP-based URL. Some suitable examples of such applications are browser applications, including, but not limited to, Firefox, Safari, and Internet Explorer.

The present invention system exposes at least two basic types of URLs: opaque URLs that cannot support relative access, and RESTful URLs that do support relative access. For example, the following URL “http://afinos.com/alpha.SampleAsync?puid=D1C0B339-1E4F-4EF3-939C-10700945A5D7&arkid=117D8B7B-732F-4DE3-A9C5-C42D4CD8484&astid4$dblob$dDF6B98A8-0568-4EEB-A4BC-CF22A9BE7FA5$fraw” is an example of an opaque URL or single-file URL because there is no way to access a file that is relative to it on the user's system. In contrast, the URL “http://afinos.com/Portal/12CD9674-94AF-427A-91B6-D3F3DCA729B6/23348895-CD2A-4BE1-8344-4888D990B5D5/default.htm” is an example of a RESTful URL or group URL because it supports relative access. That is, the file ‘default.htm’ may contain a <img src=“foo.jpg”/> tag because it is possible for the browser to compute the URL for “foo.jpg”.

The present invention system also provides three basic levels of “file serving.” The first level is static. That is, a file that is provided to another peer/non-peer user is an exact bit-for-bit copy of a file stored on the creating peer device. When provided to a peer/non-peer device, the file contents do not include recent updates or edits to the file. Thus, peers/non-peers may not receive the most recent copy of the file. The second level is bound to a local filename. However, the file that is provided to peers/non-peers is always pulled live from the local file system. This has the effect of always serving the most recent copy of the local file so that even recent edits are reflected in the file contents. The third level of file serving is bound to a local piece of code that executes and dynamically creates the file contents. This gives the user the ability to create representations of the contents even though there is no static file on the user's system that contains the contents of the file. For example, the user may create representations of file content as a thumbnail, a movie-frame extract, or an RSS feed of his or her “My Pictures” folder, even though there is no static file that contains the contents of the RSS feed of the “My Pictures” folder.

In one embodiment, the present invention also provides for dynamic applets that are provided to peers/non-peers as Adobe Flash or Microsoft Silverlight applications on a browser running on the peer/non-peer device. This functionality enables rich calendaring applications, for example. Additionally, with the present invention, the network peers can have local OpenSocial storage compatibility.

The present invention provides for proxying HTTP requests from a well-known host address. All URLs according to the present invention are referenced relative to a domain. Thus, all URLs are sent via HTTP protocol to a domain server, as identified by the domain DNS records. The domain server cluster decodes the URL to look for a CLUSTER or MACHINE ID. Once it finds the CLUSTER or MACHINE ID, it checks to see if that machine is capable of directly serving HTTP requests by way of being located behind a Universal Plug and Play (UPnP) gateway that performs Network Address Translation (NAT), or by way of being directly addressable on the Internet. If the machine is directly addressable, the domain server responds to the client browser with an HTTP-302 “temporarily moved” message comprising the IP address of the MACHINE or a machine in the CLUSTER. Otherwise, the domain server issues a FETCH peer-to-peer request to the MACHINE or CLUSTER, and spools the resulting data file back to the browser via a HTTP-200 response.

The present invention further provides for at least two levels of resource storage and retrieval. The first level facilitates the storage and retrieval of data files that are stored on a single PC via host software configured to operate according to one embodiment of the present invention. The second level facilitates the storage and retrieval of data files that are replicated across a cluster of PCs via the host software.

The present invention allows users to be persistent “zero touch” publishers by combining the users' native environment with the native communications infrastructure of the internet URLs. This allows service providers to focus on the service they are providing, not the supporting technologies. It also allows end-users to focus on the content and ownership of the files, not the steps or process required to publish the file content. Only the publishing user needs to have the host software configured according to the present invention installed. Recipients of URLs only need Internet browsing software. This lowers the technological barrier to publication because only one party has to install the network software.

There are tools that facilitate file sharing among users, such as instant messaging and email. However, these applications are “moment in time” tools in that changes and additions to file content are not made available to everyone. There are also collaboration tools that do well at sharing file content among many users communicating with one another in a conference. However, once the conference ends, access to the shared files is lost. According to one embodiment of the present invention, however, the URLs that are generated to identify the file content are “permalinks.” That is, once generated, a given URL that identifies a file will not change. Updates and edits made to the file are represented using the same URL. Where a URL is a group-type URL that identifies a group of files, a peer/non-peer device will be able to access files added to the group and updated group files upon a browser refresh.

The present invention also provides a system and method of generating a “sharing URL.” With “sharing URLs,” peers/non-peers wishing to view published file content are not required to create an account. Further, there is no upload step required for users that create the file content. Instead, a creating user places files into a folder or folder equivalent on the peer device. Software configured according to the present invention then generates a URL for each file. For example, when files are placed in a “sharing” folder, a browser starts up with the correct URL loaded in it.

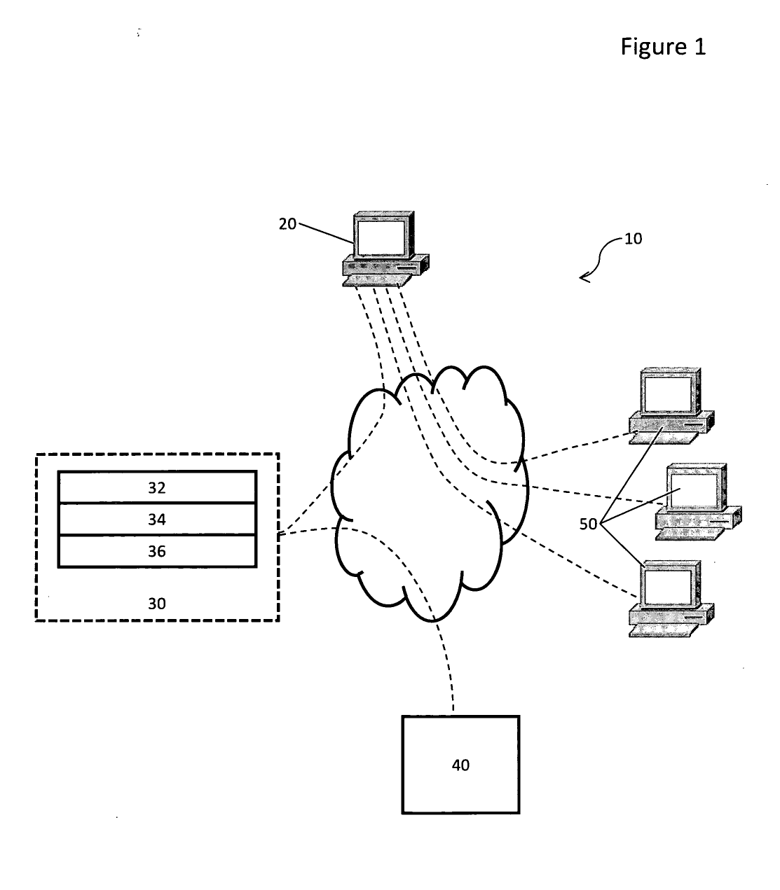

A network system according to the present invention, generally described as 10 in FIG. 1, includes a publishing computing device (PC) 20, a server 30, and an Internet Domain Name service 40. The PC 20 executes a host application configured according to one embodiment of the present invention and hosts a resource 22. PC 20 may be configured to communicate data and/or signals with third-party applications executing on one or more remote computing devices 50. The server 30 may be a single computing device and hosts a name server function 32, a web server function 34, and a host server function 36.

The following examples are intended as aids to understanding the present invention and not as limitation thereof.

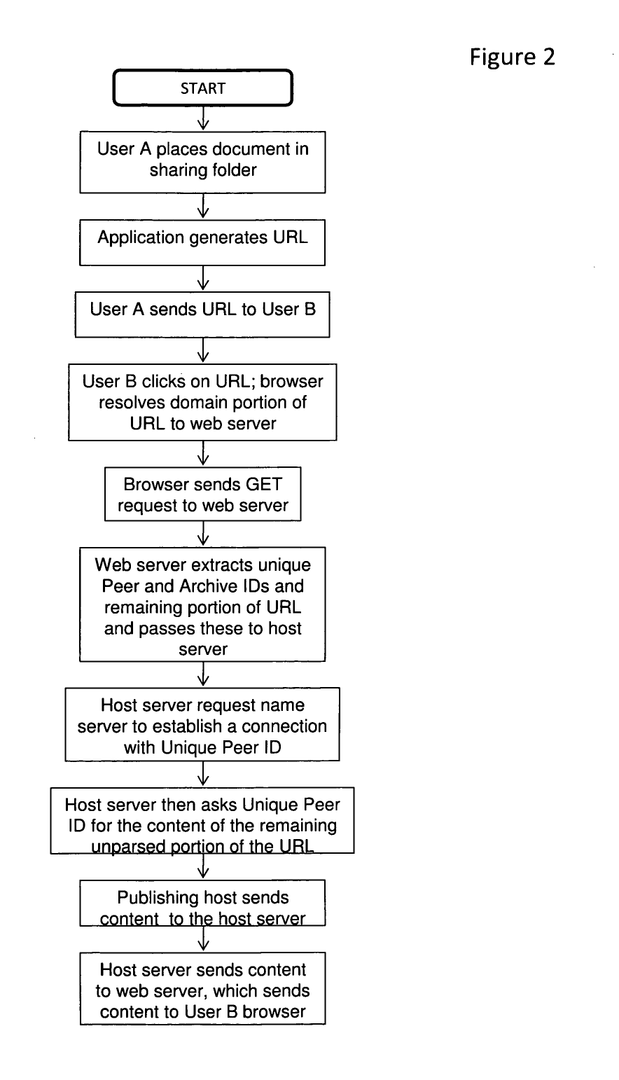

In one simple file sharing embodiment, seen in FIG. 2, Users A and B on PC 20 and PC 50, respectively, are having an Instant Messaging (IM) conversation when they decide to exchange files. In this case, both users have an IM application running on their respective PCs 20 in addition to a “sharing” application that allows users to share file content as described above. According to this embodiment:
1. User A places a document in the sharing folder for the sharing application according to the present invention.
2. A sharing application executing on User A's device generates a URL for the document that identifies the application installation and the document.
3. User A copies the URL from an Afinos application window, pastes it into the IM application window, and send it to User B.
4. User B sees the URL in his IM application window, clicks on the URL and the IM client launches his default web browser with the URL.
5. User B's web browser uses the ‘Internet Domain Name’ services 40 to resolve the domain name part of the URL back to the web server 34. The web browser then sends a GET request to the web server 34 passing the whole URL.
6. The web server 34 parses the URL to extract the unique peer ID, and the unique archive ID, and a remaining unparseable portion of the URL. It passes these three values to the host software 36, preferably running on the same physical server, to retrieve the content represented by those three values.
7. The host server 36 requests the Afinos name server 32 to help establish a connection to the given Afinos unique peer ID.
8. The host server 36 asks the PC 20 identified by the unique peer for the content of the remaining unparsed portion of the URL within the data archive unique archive ID.
9. The publishing host 20 sends the requested content back to the host server 36;
10. As it receives contiguous data, the host server 36 provides the data back to the Afinos web server 34 which streams it live back to User B's web browser.

The present invention can also include the steps of:
11. the originating user continuing to edit the file, and
12. the consuming user hitting REFRESH in the browser and receiving the updated file.

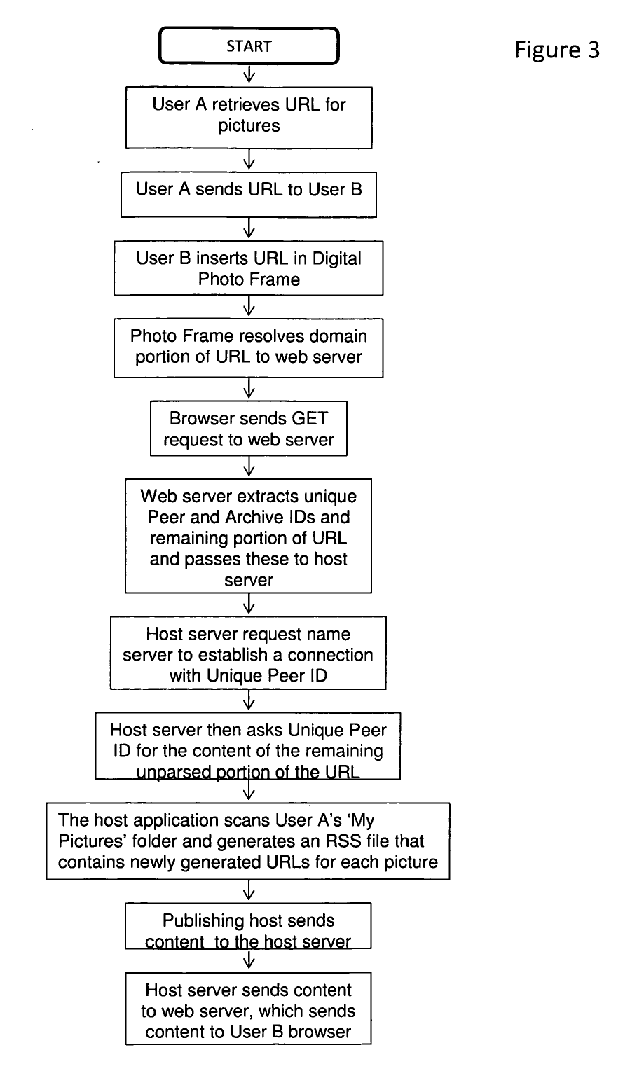

In a second embodiment, seen in FIG. 3, User A has the sharing application installed on his PC 20 and wants to be able to send photos automatically to User B's RSS-enabled photo frame. In this case, User B has an RSS-enabled photo frame on a remote computing device 50. The steps for such a file transfer include:
1. User A clicks on the ‘Get the My Pictures URL’ button in his host application 20 and sends to User B.
2. User B types this URL into his Digital Photo Frame.
3. The Digital Photo Frame uses the ‘Internet Domain Name’ services to resolve the domain name part of the URL back to the web server 34. The Digital Photo Frame executing on PC 50 then sends a GET request to the web server 34 passing the whole URL.
4. The'web server 34 parses the URL to extract the ‘unique peer ID’ and the ‘unique archive ID’ and the ‘remaining unparseable portion of the URL’. It passes these three values to the host software 36, preferably running on the same physical server, to retrieve the content represented by those three values.
5. The host server 36 requests the Afinos name server 32 to help establish a connection to the given “Afinos unique peer ID.”
6. The host server 36 asks the unique peer ID 20 for the content of the remaining unparsed portion of the URL within the data archive unique archive ID.
7. The host application on PC 20 recognizes that the requested content must be generated (i.e., it is not pre-existing) and it scans User A's ‘My Pictures’ folder. Based on the images contained therein, PC 20 generates a corresponding RSS file that contains newly generated URLs for each picture.
8. The publishing host 20 then sends the requested content back to the host server 36.
9. As it receives contiguous data, the host server 36 provides the data back to the web server 34 which streams it live back to User B's web browser.
10. The Digital Photo Frame on PC 50 parses the RSS file and fetches the photos referenced in the RSS document by URL.
Additionally, the following steps can be performed:
The RSS feed could specify movie files, i.e., Apple Quicktime™ or Microsoft's WMV, that would be generated on demand to provide transitions, for example frame-by-frame renderings of animated transitions, from one photo to the next.
The generated photo may be served up as an alpha-blended PNG photo that has been rendered in a graphical or trompe l′oeil treatment, for example in a mahogany frame with a slight shadow.
The generated photo may simply be a random photo—each time the client issues a GET the content might be different.
A publishing user may desire to automatically have certain resources automatically added to his RSS feed. In these cases, tagging the resource with a predetermined tag automatically adds the resource to his RSS feed.

In a third example, User A has the host application installed on her PC 20 and visits a website to order a piece of clothing customized with one of her pictures on it. In this example, a retailer web server and web site wholly unaffiliated with the network and not containing any of the software according to the present invention are able to take advantage of the present invention to facilitate a commercial transaction. The method steps for this file transfer include:
1. User A surfs to the retailer website in her web browser;
2. User A selects a piece of clothing to customize;
3. User A then right-clicks a picture on her computer in the Windows Explorer application, selects the “Copy HOSTING URL” option, and pasts the URL into the “enter the URL to your photo” box on the retailer website.
4. The retailer's web server uses the ‘Internet Domain Name’ services 40 to resolve the domain name part of the URL back to the web server 34. The retailer web server then sends a GET request to the web server 34 passing the whole URL;
5. The web server 34 parses the URL to extract the ‘unique peer ID’ and the ‘unique archive ID’ and the ‘remaining unparseable portion of the URL’. It passes these three values to the host software 36, preferably running on the same physical server, to retrieve the content represented by those three values;
6. The host server 36 requests the name server 32 to help establish a connection to the given ‘unique peer ID’;
7. The host server 36 asks the unique peer ID 20 for the content of the remaining unparsed portion of the URL within the data archive unique archive ID;
8. The publishing host 20 sends the requested content back to the host server 36;
9. As it receives contiguous data, the host server 36 provides the data back to the Afinos web server 34 which streams it live back to retailer's web server;
10. The retailer website generates a ‘preview’ page showing the user's chosen piece of clothing with pricing and further options. Simultaneously, the retailer's fulfillment engine begins ‘downloading’ the authoritative high-resolution imagery in the background, allowing the user to go on with the design session (placement, cut-out, shading, etc) and eventually purchase the clothing.

Additionally, the following steps can be performed:
the user selects several photos and the pasted URL is an automatically generated RSS file.
the user selects a movie and the hosting software automatically parses out the ‘significant scene changes’ in the movie and provides those as a series of photos in an RSS file.
the generated RSS file contains both the authoritative high-resolution imagery and thumbnail-resolution versions so that the retailer website can pull the right resolution of image for its needs.
the user clicks the “Copy one-time use HOSTING URL” such that the retailer may pull the image once and only once as a privacy or security measure.
the user's URL is saved in a cookie on the user's system or in the user's retailer website account information such that subsequent visits may have advertisements or product placements created from those photos on the user's PC.
The user's HOSTING folder is exposed as an RSS feed to companies which can then send an email that includes products with the user's resources mocked in as they are added to the user's computer.

Other examples include using the system and method of the present invention as Internet TV. Particularly, user A may place a movie file into a “hosting” folder on the user's peer device. A remote device such as an Internet TV, automatically determines that the movie file was placed in the “hosting” folder via a RSS feed and plays itself. The present invention can also be extended to be a TV channel editing system. MORE EXPLANATION HERE

In the area of shared Photos, a user could simply mail the URL for a folder containing digital photos without having to go through an upload process at all. The peer software would prepare an HTML thumbnail grid of those photos, which as they were clicked on would pull the photos from the user's PC. Both the folder and the photos would have uniquely generated URLs.

The present invention is further directed to resource-generating device wherein the device automatically creates a URL for resources generated on the device. As stated previously, the resource is accessible from a public network such as the Internet while still on the device via the URL. The device further includes an update feed for new and newly-modified resources on the device.

For example, the device may be a digital camera in wireless communication with the Internet. When a picture is taken, the device automatically creates a URL for the picture, and the URL is sent out on an RSS feed. Alternatively, the user of the digital camera may be prompted as to whether he wants a URL created and sent out for a picture immediately after the picture is taken.

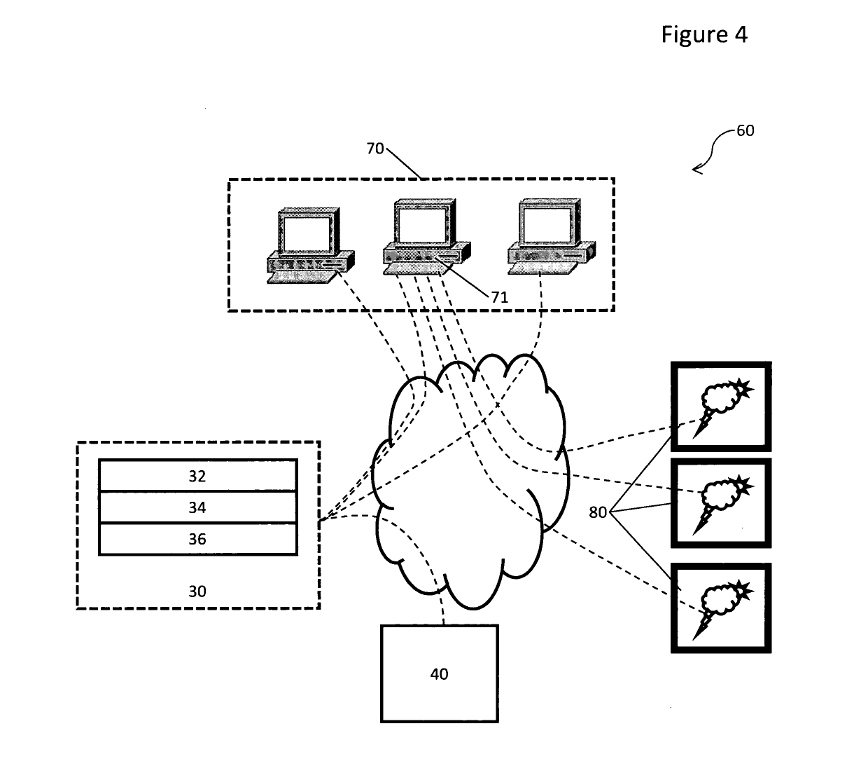

The present invention is further directed to a network, generally shown as 60 in FIG. 4, of at least one resource-generating device 71 in communication with at least one resource-publishing device 80 by a method according to the present invention. In an embodiment, the at least one resource-generating device 71 is a peer in a peer-to-peer network and acts as a feed aggregator, such as an RSS feed aggregator, and pushes the feed to the at least one resource-publishing device 80. In a preferred embodiment, the feed is a random feed, the resources are digital images and the resource-publishing device is a digital image display appliance. Thus, in a preferred embodiment, the present invention provides for peer-to-peer network wherein one of the peers aggregates and randomly feeds digital images to one or more non-peer-to-peer image display devices using a RESTful URL of non-addressable images.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

I claim:

1. A system for providing URL accessibility to peer-network-hosted content, comprising: a publishing PC running a host application and hosting a resource, a name server, a web server, a host server, and an Internet Domain Name service, wherein resources hosted on the peers are accessible by a public network site via a uniform resource locator (URL).

2. The system of claim 1, wherein the URL type is selected from the group consisting of opaque URLs and RESTful URLs.

3. The system of claim 1, wherein the network is in communication with at least one third-party application on at least one digital appliance.

4. The system of claim 1, wherein the peer-to-peer network further includes an update feed for new and newly-modified resources on the network.

5. A method for providing URL accessibility to peer-network-hosted content, the method steps comprising:
a. providing a peer-network, the network comprising a publishing PC running a host application and hosting a resource, a name server, a web server, a host server, an Internet Domain Name service and a second network user;
b. a first user placing a document in a sharing folder for a sharing application on the publishing PC;
c. the sharing application generating a URL for the document that identifies the application installation and the document;
d. the first user copying the URL from the Afinos application window, pasting it into the IM application window and sending it to a second user;
e. the second user clicking on the URL and the IM client launching the web browser with the URL;
f. the second user's web browser using the ‘Internet Domain Name’ services to resolve the domain name part of the URL back to a web server. The web browser then sending a GET request to the web server passing the whole URL;
g. the web server parsing the URL to extract the ‘unique peer ID’ and the ‘unique archive ID’ and the ‘remaining unparseable portion of the URL’;
h. the web server passing these three values to the host software to retrieve the content represented by those three values;
i. the host server requesting the name server to help establish a connection to the given ‘unique peer ID’;
j. the host server asking the unique peer ID for the content of the remaining unparsed portion of the URL within the data archive unique archive ID;
k. the publishing host sending the requested content back to the host server;
l. the host server receiving the contiguous data and providing the data back to the web server which streams it live back to the second user's web browser.

6. The method of claim 5, further including the step of:
a. the first user continuing to edit the file, and
b. the second user hitting REFRESH in the browser and receiving the updated file.

7. A system for sharing digital resources, the system comprising a resource-generating device, wherein the device automatically creates a URL for resources generated on the device and the resource is accessible from a public network while still on the device via the URL.

8. The device of claim 7, further including an update feed for new and newly-modified resources on the device.

9. The device of claim 7, wherein the device is a digital camera in wireless communication with the Internet.

10. The device of claim 7, wherein the URL type is selected from the group consisting of opaque URLs and RESTful URLs.

11. The device of claim 9, further including an RSS-enabled photo frame to view the resources.

12. The device of claim 9, further including a streaming video application on a second device on the public network for viewing videos shared by the resource-generating device.
